(19) United States
(12) Patent Application Publication
(10) Pub. No.: US 2006/0097669 A1
(43) Pub. Date: May 11, 2006

(54) Electron tube

(75) Inventors: Satoru Teshima, Sagamihara-shi (JP); Akihiko Kasahara, Sagamihara-shi (JP)

Correspondence Address: YOUNG & THOMPSON, 745 SOUTH 23RD STREET, 2ND FLOOR, ARLINGTON, VA, 22202, US

(73) Assignee: NEC MICROWAVE TUBE, LTD., SAGAMIHARA-SHI (JP)

(21) Appl. No.: 11/261,636

(22) Filed: Oct. 31, 2005

(30) Foreign Application Priority Data
Nov. 8, 2004 (JP) 2004-323836

(51) Int. Cl. H05H 7/00

(52) U.S. Cl. 315/500

(57) ABSTRACT

An electron tube is provided with a plurality of supports, a portion of the support covered with conductive material abuts the inner wall of the shell, and another portion of the support covered with dielectric abuts the helix. The helix which is used as a high-frequency circuit for bringing about interaction between an electron beam and a high-frequency signal is supported and fixed within the shell by plurality of supports.

### BACKGROUND OF THE INVENTION

1. Field of the Invention

The present invention relates to an electron tube having a helix which will be used as a high-frequency circuit for bringing about interaction between an electron beam and a high-frequency signal.

2. Description of the Related Art

There are known electron tubes such as a traveling-wave tube or a klystron, for amplifying and oscillating a high-frequency signal by interaction between an electron beam emitted from an electron gun and a high-frequency circuit. One of these electron tubes, as shown in FIG. 1, is provided with electron gun 10 for emitting electron beam 50, spiral-shaped helix 20 to be used as a high-frequency circuit for bringing about interaction between electron beam 50 emitted from electron gun 10 and a high-frequency signal (microwave), collector electrode 30 for capturing electron beam 50 passing through helix 20, and anode 40 for introducing electron beam 50 emitted from electron gun 10 into the spiral structure of helix 20.

Electron gun 10 is provided with cathode 11 for emitting thermoelectrons, heater 12 for giving cathode 11 thermal energy for the emission of thermoelectrons, and Wehnelt electrode 13 for concentrating thermoelectrons to form electron beam 50.

Predetermined power supply voltages are respectively supplied to collector electrode 30 and electron gun 10 in the electron tube shown in FIG. 1, and anode 40 and helix 20 are each connected to the shell of the electron tube so as to be grounded.

A common negative high voltage (cathode voltage) is supplied to cathode 11 and Wehnelt electrode 13 of electron gun 10 from power supply 60; a predetermined voltage is supplied to heater 12 based on the cathode voltage. Also, a positive high voltage is supplied to collector electrode 30 based on the cathode voltage. Alternatively, an electron tube is known in which anode 40 and helix 20 are separated and various power supply voltages are supplied to anode 40 and helix 20.

Electron beam 50 emitted from electron gun 10 is accelerated by anode electrode 40 and introduced into the spiral structure of helix 20, and travels inside the structure of helix 20 while interacting with the high-frequency signal supplied from the input end of helix 20. Electron beam 50 output from the spiral structure of helix 20 is captured by collector electrode 30 while the high-frequency signal amplified by interaction with electron beam 50 is output from the output end of helix 20.

Helix 20, as shown in FIGS. 2A and 2B, is supported by supports 22 (usually, three supports) made of dielectrics and fixed in shell 21. On the inner wall of shell 21, vein 23 (also called, solid) made of metal material is inserted in a radial direction in order to conduct signals over a wide range of frequencies by reducing changes with reference to the frequency in the phase speed of the high-frequency signal (microwave) supplied to helix 20 and with reference to the interaction impedance of electron beam 50 and the high-frequency signal. For example, a method for arranging vein 23 in shell 21 so that electron tube 1 can be used over a wide range of frequencies is described in Non-Patent Document (Onodera, Tsuji, “Dispersion Characteristic of Loading Helix for Ultra-Wide Band Traveling Wave Tube”, The Institute of Electronics, Information and Communication Engineers, September 1987, vol. J70-C, No. 9, pp. 1286-1287.). In this paper, the shell is called a barrel and the vein is called a metal segment.

As shown in FIGS. 2A and 2B, when helix 20 is fixed in shell 21, helix 20 to which supports 22 are attached is fitted to shell 21 by means of heat shrinking, and then veins 23 are fixed to positions so as not to overlap with supports 22 on the inner wall of shell 21 (at intervals of angles of 120 degrees) by brazing. As a result, it is difficult to attach veins 23 and there is a problem in that the defective rate in the attaching process of veins 23 is high. In particular, recent electron tubes are used at higher frequencies in view of the large capacity of communications system and in view of the effective use of radio waves, and therefore, electron tubes become smaller to conform to higher frequencies. Hence, heat shrinking allowance between helix 20 and shell 21 tend to be small, there is a strong possibility that helix 20 or supports 22 will collapse during attachment of veins 23, and attachment of veins 23 tends to be more difficult.

To deal with these disadvantages, for example, Patent Document 1 (Japanese Patent Laid-Open publication No. 242817/1993) discloses that steps are arranged on one or both sides of the supports (dielectric) for supporting the helix and that metal plating is applied to the steps, so that the support functions as vein and veins are unnecessary.

However, in the conventional structure disclosed in Patent Document 1, because a technique for accurately applying metal plating to the steps arranged on the support made of dielectrics has not been established, there is a problem that the defective rate in the process of forming supports is high.

Therefore, the problems that occur are that cost of manufacturing electron tubes increases and electron tubes cannot be used over a wide range of frequencies.

### SUMMARY OF THE INVENTION

It is therefore an object of the present invention to provide an electron tube which has low manufacturing costs (in which manufacturing costs are suppressed) and which can be used over a wide range of frequencies.

To achieve the object, according to the present invention, an electron tube is provided with a plurality of supports, a portion of which is covered with conductive material, these supports covered with conductive material abut an inner wall of the shell, and another portion of the supports covered with a dielectric abuts the helix, and a helix to be used as a high-frequency circuit for bringing about interaction between the electron beam and a high-frequency signal is supported and fixed within the shell by plurality of supports.

In the electron tube according to this arrangement, the conductive material that included the support, rather than the veins, contributes to the electron tube being able to operate over a wide range of frequencies, and therefore it is not necessary to arrange veins on the inside of the shell. In particular, since the dielectric is formed on the surface of the conductive material, the supports can be formed by an established technique such as the CVD (Chemical Vapor Deposition) method and the defective rate in the process of forming the supports is improved. Therefore, it is possible to obtain an electron tube in which an increase of manufacturing costs is suppressed and which can be used over a wide range of frequencies.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a side sectional view showing an example of the configuration of an electron tube having a helix;

FIG. 2A is a sectional view showing the configuration of the conventional helix that is shown in FIG. 1;

FIG. 2B is a side sectional view showing the configuration of the conventional helix that is shown in FIG. 1;

FIG. 3A is a side sectional view showing a first embodiment of the configuration of an electron tube of the present invention;

FIG. 3B is a perspective view showing the configuration of a support that is shown in FIG. 3A;

FIG. 4 is a perspective view showing the configuration of a modification of the support that is shown in FIG. 3A;

FIG. 5A is a sectional view showing a second embodiment of the configuration of an electron tube of the present invention; and

FIG. 5B is a perspective view showing the configuration of a support that is shown in FIG. 5A.

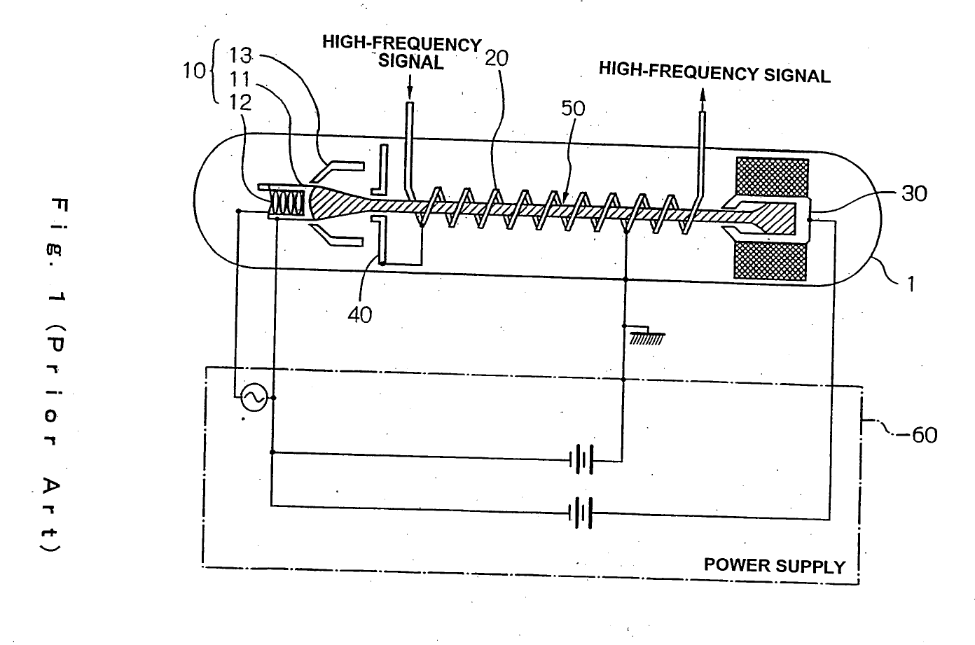

### DETAILED DESCRIPTION OF THE PREFERRED EMBODIMENTS

### First Embodiment

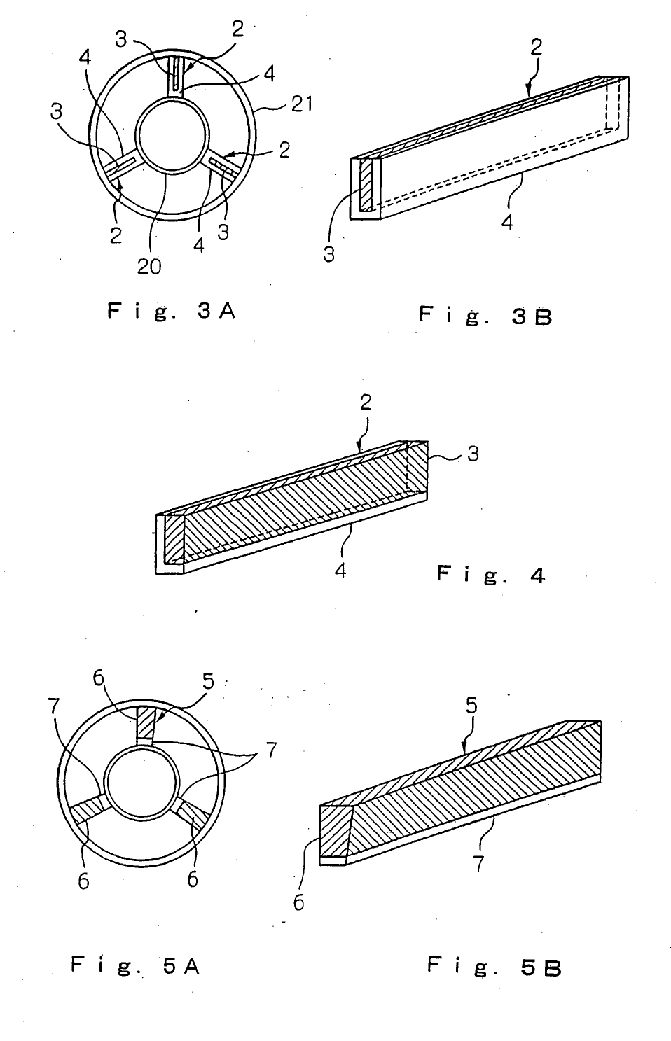

FIG. 3A is a side sectional view showing a first embodiment of the configuration of an electron tube of the present invention, and FIG. 3B is a perspective view showing the configuration of a support that is shown in FIG. 3A. FIG. 3A shows a sectional view in a direction orthogonal to the flow of the electron beam.

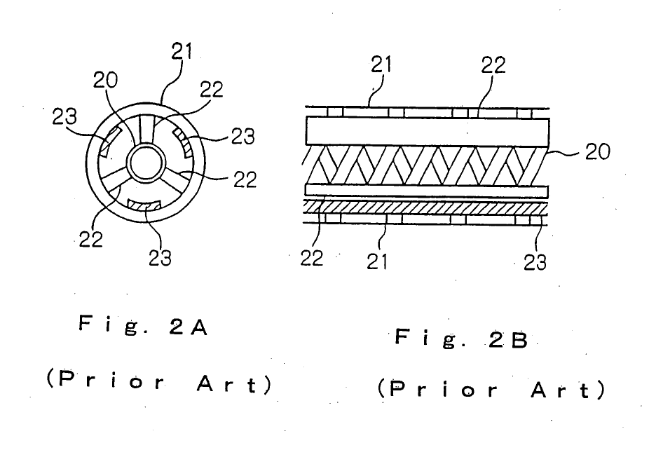

As shown in FIGS. 3A and 3B, in the electron tube of the first embodiment, supports 2 for supporting helix 20 within shell 21 are different from those of the conventional electron tube. The construction is otherwise identical to an electron tube of the prior art shown in FIGS. 2A and 2B and explanation of this construction is therefore here omitted.

Support 2 in the electron tube of the first embodiment is formed by covering dielectric 4 onto the surface of conductive material 3 in such a manner that dielectric 4 is exposed at the region abutting on the inner wall of shell 21. Hence, conductive material 3 comes in contact with the inner wall of shell 21 in the radial direction. Additionally, FIGS. 3A and 3B show that dielectrics 4 are arranged on both sides of plate-shaped conductive material 3, however, conductive material 3 is not limited to the plate shape and may be formed in any shape such as a trapezoid and a L-shape. Further, support 2 may be formed in any shape as long as conductive material 3 is arranged at the region abutting the inner wall of shell 21, and as long as a region that is in contact with helix 20 is covered with dielectric 4. For example, dielectric 4 is formed in a L-shape on the surface of conductive material 3 as shown in FIG. 4.

Non-magnetic material such as copper and graphite is used for conductive material 3. Boron nitride or aluminum nitride is used for dielectric 4 that covers conductive material 3. On the surface of conductive material 3, for example, dielectric 4 is deposited by CVD (Chemical Vapor Deposition) method.

In the electron tube of the first embodiment, conductive material 3 in support 2 reduces changes with reference to the frequency in the phase speed of high-frequency signal (microwave) supplied to helix 20, and reduces changes in the interaction impedance of electron beam and high-frequency signal so as to contribute to the electron tube being used over a wide rage of frequencies. Hence, veins 23 are unnecessary, the process of attaching veins 23 is not required, and therefore, the cost of electron tube is reduced.

Also, in the first embodiment, compact electron tubes being able to operate over a wide range of frequencies can be obtained by the same manufacturing method as the conventional method because veins 23 is not needed.

Further, in the first embodiment, it is possible to produce support 2 by forming dielectric 4 on the surface of conductive material 3 with established techniques such as the CVD method rather than by applying metal plating to support 2 which is made of dielectric as described in Patent Document 1. The defective rate is improved during the process of forming support 2. Hence, an increase in the cost of electron tubes can be suppressed while the electron tube can be used over a wide range of frequencies.

### Second Embodiment

FIG. 5A is a sectional view showing a second embodiment of the configuration of an electron tube of the present invention, and FIG. 5B is a perspective view showing the configuration of a support that is shown in FIG. 5A. FIG. 5A shows a sectional view in a direction orthogonal to the flow of the electron beam.

As shown in FIGS. 5A and 5B, in the electron tube of the second embodiment, conductive material 6 is used for the material in as support 5 for supporting helix 20 within shell 21, and a region abutting helix 20 is covered with dielectric film 7. The construction is otherwise identical to an electron tube of the prior art shown in FIGS. 2A and 2B and explanation of this construction is therefore here omitted.

Non-magnetic material such as copper and graphite is used for conductive material 6, as in the first embodiment. Boron nitride or aluminum nitride is used for dielectric film 7. On the region abutting helix 20, dielectric film 7 is formed by the CVD method.

In the electron tube of the second embodiment, as with the first embodiment, conductive material 6 which is used in support 5, rather than vein 23 shown in FIG. 2, contributes to the electron tube being able to operate over a wide range of frequencies. Hence, veins 23 are unnecessary, the process of attaching veins 23 is not required, and therefore, the cost of electron tubes is reduced.

Also, in the second embodiment, compact electron tubes operating over wide range frequencies can be obtained by the same manufacturing method as the conventional method because veins 23 are not needed in the construction of the electron tube.

Further, in the second embodiment, it is possible to produce support 5 by forming dielectric film 7 on the surface of conductive material 6 with established techniques such as the CVD method. The defective rate is improved in the process of forming support 5. Hence, an increase in the cost of electron tube can be suppressed while the electron tube can be used over a wide range of frequencies.

While preferred embodiments of the present invention have been described using specific terms, such description is for illustrative purposes only, and it is to be understood that changes and variations may be made without departing from the spirit or scope of the following claims.

What is claimed is:

1. An electron tube having a helix which is used as a high-frequency circuit for bringing about interaction between an electron beam and a high-frequency signal, said electron tube comprising:
a shell for holding the helix therein; and
a plurality of supports for supporting the helix within said shell, a portion of said support covered with conductive material abuts an inner wall of said shell, and other portion of said support covered with dielectric abuts said helix.

2. The electron tube according to claim 1, wherein said support is provided with the dielectric formed on a surface of said conductive material and said conductive material is exposed in the potion abutting the inner wall of said shell.

3. The electron tube according to claim 1, wherein said support composed of conductive material and a portion of the support is covered with a dielectric film abuts said helix.
